(19) United States
(12) Patent Application Publication
(10) Pub. No.: US 2018/0208503 A1
(43) Pub. Date: Jul. 26, 2018

(54) GLASS COMPRISING A FUNCTIONAL COATING CONTAINING SILVER AND INDIUM

(71) Applicant: SAINT-GOBAIN GLASS FRANCE, Courbevoie (FR)

(72) Inventors: Jan HAGEN, BONN (DE); Norbert HUHN, Herzogenrath (DE)

(21) Appl. No.: 15/741,962

(22) PCT Filed: Jun. 30, 2016
(86) PCT No.: PCT/FR2016/051644

§ 371 Date: Jan. 4, 2018

(30) Foreign Application Priority Data
Jul. 6, 2015 (FR) 1556369

(51) Int. Cl. C03C 17/36

(52) U.S. Cl. CPC C03C 17/3618; C03C 17/366; C03C 17/3626; C03C 2217/27; C03C 17/3644; C03C 17/3647; C03C 17/3649; C03C 17/3639

(57) ABSTRACT

A material includes a transparent substrate coated with a stack of thin layers including at least one silver-based functional metal coating, at least two dielectric coatings including at least one dielectric layer, so that each functional metal coating is positioned between two dielectric coatings, wherein the functional metal coating includes at least 1% by weight of indium relative to the weight of silver and indium in the functional metal coating.

The invention relates to a material and to a process for preparing a material, such as glazing, comprising a transparent substrate coated with a stack of thin layers comprising a functional coating that acts on infrared radiation.

A functional coating comprises at least one functional layer. A “functional” layer is understood within the meaning of the present application as meaning the layer (or layers) of the stack that gives it most of its thermal properties. The functional layer acts on solar and/or thermal radiation essentially by reflection and/or absorption of the near (solar) or far (thermal) infrared radiation.

These functional layers are deposited between coatings based on dielectric materials (hereinafter dielectric coatings) generally comprising several dielectric layers that make it possible to adjust the optical properties of the stack. The functional coatings act on the flux of solar radiation passing through said glazing, as opposed to the other dielectric coatings, generally made of dielectric material and having the role of chemical or mechanical protection of the functional coating.

The best performing stacks comprise a silver-based functional layer (or silver layer). These silver layers are used in several ways: by reflecting the thermal or solar infrared radiation, they give the material low-emissivity or solar-control functions. Electrically conductive, they also make it possible to obtain conductive materials, for example heated glazings or electrodes.

These silver layers are however very sensitive to corrosion, in particular in a wet environment. They must not be exposed to the open air in order to be protected against the chemical attacks of agent such as water, sulfur and salt.

These silver layers are therefore conventionally used inside laminated glazings or in multiple glazings such as double glazings, on face 2 or 3, numbering the faces of the substrate(s) from the outside to the inside of the building or passenger compartment that they equip. Such layers are not in general deposited on single glazings (also referred to as monolithic glazings).

Likewise, certain dielectric layers used in the dielectric coatings are also sensitive to corrosion in a wet environment such as the layers based on zinc oxide that are commonly used as a wetting layer below the silver layers to promote the crystallization thereof.

One solution proposed for improving the chemical resistance consists in doing away with the use, in the dielectric coatings, of all corrosion-sensitive dielectric layers. Although the materials thus formed have an improved durability, the corrosion resistance of the stack, when it is directly exposed to the surrounding air during a lengthy storage or under normal operating conditions, remains insufficient.

Added to this is the fact that such materials must frequently undergo high-temperature heat treatments, intended to improve the properties of the substrate and/or of the stack of thin layers. This may be for example, in the case of glass substrates, a heat treatment of tempering, annealing and/or bending type.

Ideally, the materials must be capable of undergoing, once coated with the stack, a high-temperature heat treatment, without significant variation, or at least without deterioration of their initial optical and/or energy properties. In particular, after heat treatment, the materials must retain an acceptable light transmission and have an emissivity that is preferably substantially improved, or at the very least substantially unchanged.

The mechanical strength and chemical resistance of these materials comprising complex stacks subjected to high-temperature heat treatments is often insufficient, all the more so when the functional layers are silver-based metal layers. This poor strength or resistance is expressed by the appearance in the short term of defects such as corrosion sites, scratches, or even the complete or partial delamination of the stack during the use thereof under normal conditions. Any defects or scratches, whether they are due to corrosion, to mechanical stresses or to a poor adhesion between adjacent layers, are capable of impairing not only the attractiveness of the coated substrate but also its optical and energy performances.

Finally, the application of such high-temperature heat treatments on materials sensitive to corrosion in particular in a wet environment increases their deterioration even more.

The invention therefore consists of the development of novel materials comprising a silver-based functional coating having a high chemical resistance while maintaining the thermal and optical properties of the stack, with a view to manufacturing improved solar protection glazings, in particular low-emissivity glazings.

Finally, another objective is to provide a material equipped with a stack that is capable of withstanding the heat treatments without damage, in particular when the substrate bearing the stack is of glass type. This is expressed by an absence in the variation of its thermal and optical properties before and after heat treatment, in particular of tempering type.

The applicant has surprisingly discovered that the use of a functional metal coating based on silver and indium in the proportions claimed makes it possible to improve the chemical resistance without adversely affecting the thermal and energy properties. The presence of indium in chosen proportions does not increase the emissivity significantly.

The invention relates to a material comprising a transparent substrate coated with a stack of thin layers comprising at least one silver-based functional metal coating, at least two dielectric coatings comprising at least one dielectric layer, so that each functional metal coating is positioned between two dielectric coatings, characterized in that the functional metal coating comprises, in order of increasing preference, at least 1.0% by weight of indium relative to the weight of silver and indium in the functional metal coating.

When it is desired to control the increase in the emissivity, the maximum proportions of indium in the functional coating are chosen below a threshold value. According to embodiments of the invention, the functional metal coating comprises, in order of increasing preference:
at most 10.0%, at most 9.0%, at most 8.0%, at most 7.0%, at most 6.0%, at most 5.0%, at most 4.0%, at most 3.5%, at most 3.0%, at most 2.5% by weight of indium relative to the weight of silver and indium in the functional metal coating,
at least 1.0%, at least 1.5%, at least 2.0% by weight of indium relative to the weight of silver and indium in the functional metal coating.

According to preferred embodiments, the functional metal coating comprises, in order of increasing preference, 1.0% to 5.0%, 1.0% to 4.0%, 1.0% to 3.0%, 1.5% to 3.0%, 2% to 3.5% by weight of indium relative to the weight of silver and indium in the functional metal coating.

The stack is located on at least one of the faces of the transparent substrate.

The proportions of indium in the functional metal coating are optimized:
for proportions of less than 1%, the effect of improving the wet corrosion resistance is not observed and
for proportions of greater than 5%, or even greater than 4%, a slight opacification (haze) of the coating and/or a slight deterioration of the conductivity occurs following the high-temperature heat treatment, and
for proportions of less than 3%, the emissivity of the stack is not increased significantly, in particular following a high-temperature heat treatment, relative to a similar stack based on a functional coating based solely on silver.

The functional coating may comprise a single layer based on an alloy of silver and indium or a sequence of several layers of silver and indium.

The functional coating may therefore comprise:
a metal layer based on an alloy of silver and indium,
at least one indium-based metal layer and at least one silver-based metal layer.

The use of indium as dielectric layer constituent is known with, in particular, dielectric coatings comprising indium tin oxide. However, these dielectric layers are sensitive to corrosion and to aging. What is determining for improving the chemical resistance of the stacks is the presence of indium at the heart of the functional coating either in the form of an alloy with silver, or in the form of a silver-indium layer sequence. The use of a superjacent or subjacent layer based on indium in nonmetallic form does not make it possible to obtain the advantageous effects of the invention.

According to the invention, a material having the following characteristics was able to be obtained:
a high conductivity,
a low emissivity (c), preferably between 1% and 20% and better still between 1% and 10%,
a good resistance to the high-temperature heat treatment of tempering or annealing type,
a good chemical durability that is expressed in particular by the absence of visible damage in the aging tests such as the test of resistance to high humidity,
pleasant colors in transmission and
a high transparency and an acceptable absorption, in particular of less than or equal to 20%.

The transparent substrate coated with the stack according to the invention has a light transmission of greater than 50%, preferably of greater than 60%.

The preferred characteristics which appear in the continuation of the description are applicable both to the material according to the invention and, where appropriate, to the process according to the invention.

All the luminous characteristics presented in the present description are obtained according to the principles and methods described in European standards EN 410 and EN 673 relating to the determination of the luminous and solar characteristics of the glazings used in glass for construction.

The stack is deposited by magnetic-field-assisted cathode sputtering (magnetron process). According to this advantageous embodiment, all the layers of the stack are deposited by magnetic-field-assisted cathode sputtering. However, other deposition processes are possible, for example spraying and ion-beam evaporation.

Unless indicated otherwise, the thicknesses alluded to in the present document are physical thicknesses and the layers are thin layers. Thin layer is intended to mean a layer with a thickness of between 0.1 nm and 100 micrometers.

Throughout the description, the substrate according to the invention is regarded as being positioned horizontally. The stack of thin layers is deposited above the substrate. The meaning of the expressions “above” and “below” and “lower” and “upper” is to be considered with respect to this orientation. Unless specifically stipulated, the expressions “above” and “below” do not necessarily mean that two layers and/or coatings are positioned in contact with one another. When it is specified that a layer is deposited “in contact” with another layer or with a coating, this means that there cannot be one or more layers inserted between these two layers.

A silver-based functional metal coating comprises, in order of increasing preference, at least 90.0%, at least 95.0%, at least 96.0%, at least 97.0%, at least 97.5% by weight of silver relative to the weight of the functional metal coating.

According to one embodiment, the functional metal coating additionally comprises tin. In order of increasing preference, the functional metal coating comprises 0.05% to 5%, 0.05% to 1.0%, 0.1% to 1.0% by weight of tin relative to the weight of silver, indium and tin in the functional metal coating.

The functional metal coating may also comprise other dopant elements, for example palladium, gold or platinum. According to the invention, “other dopant elements” is understood to mean elements not chosen from silver, indium and tin. Preferably, these other dopant elements represent, in order of increasing preference, less than 10%, less than 5%, less than 1%, less than 0.5% by weight of the functional coating.

Preferably, the functional metal coating comprises less than 1.0%, preferably less than 0.5% by weight of other dopant elements relative to the weight of the silver-based functional metal coating.

The silver-based functional metal coating has, in order of increasing preference, a thickness of between 5 and 20 nm, 8 and 18 nm, 10 and 16 nm.

Preferably, the functional coating comprises a layer based on an alloy of silver and indium. An alloy is understood to mean a mixture of several metals. The alloy may be obtained by co-deposition from two metal targets, one of indium and the other of silver or by deposition from a target that already comprises an alloy of silver and indium. When the functional coating comprises a layer based on an alloy of silver and indium, the thickness of the coating corresponds to the thickness of the layer based on an alloy of silver and indium and is preferably from 5 to 20 nm, from 8 to 18 nm of from 10 to 16 nm.

The functional coating may also comprise a sequence of silver and indium layers.

According to an embodiment, this sequence of layers begins with a silver layer and finishes with an indium layer or begins with an indium layer and finishes with a silver layer. The functional coating may therefore comprise at least one indium-based metal layer and at least one silver-based metal layer.

According to another embodiment, this sequence of layers begins and/or finishes with a silver layer. The functional coating may therefore comprise at least one indium-based metal layer and at least two silver-based metal layers, so that each indium-based metal layer is positioned between two silver-based metal layers.

According to another embodiment, this sequence of layers begins and finishes respectively with an indium layer. In this case, the functional coating may therefore comprise at least one silver-based metal layer and at least two indium-based metal layers, so that each silver-based metal layer is positioned between two indium-based metal layers.

Surprisingly, it has been shown that a high-temperature heat treatment on the sequence (Ag—In)n, (In—Ag)n, Ag—(In—Ag)n or In—(Ag—In)n leads to a sufficiently good “mixture” being obtained so that the sheet resistivity after heat treatment is almost identical to the sheet resistivity after heat treatment of a similar stack based on a functional coating solely based on silver.

According to these embodiments, the functional coating comprises at least one indium-based metal layer and at least two silver-based metal layers, so that each indium-based metal layer is positioned between two silver-based metal layers. The functional coating may therefore comprise:
1 to 7, preferably 1 to 5 indium-based metal layers and
2 to 8, preferably 2 to 6 silver-based metal layers.

By way of illustration, the stacks may comprise functional coatings comprising the sequences of layers below:
Ag/In/Ag,
Ag/In/Ag/In/Ag,
Ag/In/Ag/In/Ag/In/Ag,
Ag/In/Ag/In/Ag/In/Ag/In/Ag,
Ag/In/Ag/In/Ag/In/Ag/In/Ag/In/Ag,
Ag/In/Ag/In/Ag/In/Ag/In/Ag/In/Ag/In/Ag,
Ag/In/Ag/In/Ag/In/Ag/In/Ag/In/Ag/In/Ag/In/Ag,
In/Ag/In,
In/Ag/In/Ag/In,
In/Ag/In/Ag/In/Ag/In,
In/Ag/In/Ag/In/Ag/In/Ag/In,
In/Ag/In/Ag/In/Ag/In/Ag/In/Ag/In,
In/Ag/In/Ag/In/Ag/In/Ag/In/Ag/In/Ag/In,
In/Ag/In/Ag/In/Ag/In/Ag/In/Ag/In/Ag/In/Ag/In,
Ag/In,
Ag/In/Ag/In,
Ag/In/Ag/In/Ag/In,
Ag/In/Ag/In/Ag/In/Ag/In,
Ag/In/Ag/In/Ag/In/Ag/In/Ag/In,
Ag/In/Ag/In/Ag/In/Ag/In/Ag/In/Ag/In,
Ag/In/Ag/In/Ag/In/Ag/In/Ag/In/Ag/In/Ag/In,
In/Ag,
In/Ag/In/Ag,
In/Ag/In/Ag/In/Ag,
In/Ag/In/Ag/In/Ag/In/Ag,
In/Ag/In/Ag/In/Ag/In/Ag/In/Ag,
In/Ag/In/Ag/In/Ag/In/Ag/In/Ag/In/Ag,
In/Ag/In/Ag/In/Ag/In/Ag/In/Ag/In/Ag/In/Ag,
   with:
   Ag corresponding to a silver-based functional metal layer,
   In corresponding to an indium-based functional metal layer.

The thickness of each silver-based metal layer is, in order of increasing preference, from 0.5 to 10.0 nm, from 1.0 to 5.0 nm, from 2.0 to 3.0 nm. The thickness of each indium-based metal layer is, in order of increasing preference, from 0.05 to 5.0 nm, from 0.1 to 2 nm, from 0.1 to 1 nm, from 0.1 to 0.5 nm, from 0.1 to 0.3 nm.

The silver-based functional metal coating may be protected by a metal layer often described as a blocking layer. According to this embodiment, the stack of thin layers additionally comprises at least one blocking layer located in contact and above and/or below the functional metal coating.

The blocking layers are chosen from metal layers based on a metal or on a metal alloy, metal nitride layers, metal oxide layers and metal oxynitride layers of one or more elements chosen from titanium, nickel, chromium, tantalum and niobium, such as Ti, TiN, TiOₓ, Nb, NbN, Ni, NiN, Cr, CrN, NiCr or NiCrN. When these blocking layers are deposited in the metal, nitride or oxynitride form, these layers can undergo a partial or complete oxidation according to their thickness and the nature of the layers which frame them, for example, during the deposition of the following layer or by oxidation in contact with the underlying layer.

According to one advantageous embodiment, the silver-based functional metal coating is located in contact with and between two blocking layers.

The blocking layers are preferably chosen from metal layers, in particular layers of a nickel-chromium (NiCr) alloy.

Each blocking layer has a thickness of between 0.1 and 5.0 nm. The thickness of these blocking layers is preferably:
at least 0.1 nm, or at least 0.2 nm, and/or
at most 5.0 nm, or at most 2.0 nm.

The stack of thin layers may comprise a single functional coating.

An example of a suitable stack according to the invention comprises:
a dielectric coating located below the functional metal coating,
a functional metal coating,
a dielectric coating located above the functional metal coating,
optionally a protective layer.

The functional coatings are deposited between dielectric coatings.

The dielectric coatings have a thickness of greater than 10 nm, preferably between 15 and 100 nm, 20 and 70 nm and better still between 30 and 50 nm.

The dielectric layers of the dielectric coatings have the following characteristics, alone or in combination:
they are deposited by magnetic-field-assisted cathode sputtering;
they are chosen from oxides or nitrides of one or more elements chosen from titanium, silicon, zirconium, aluminum, tin and zinc,
they have a thickness of greater than 2 nm, preferably of between 2 and 100 nm.

Preferably, the dielectric layers have a barrier function. Dielectric layers having a barrier function (hereinafter barrier layers) are understood to mean a layer made of a material capable of forming a barrier to the diffusion of oxygen and water at high temperature, originating from the ambient atmosphere or from the transparent substrate, toward the functional layer. The barrier layers may be based on silicon and/or aluminum compounds chosen from oxides such as SiO₂, TiO₂, nitrides such as silicon nitride Si₃N₄ and aluminum nitrides AlN, and oxynitrides SiOₓN_{y}, optionally doped by means of at least one other element such as zirconium, tin or titanium. The barrier layers may also be based on tin oxide SnO₂ or based on tin zinc oxide SnZnOₓ.

According to an embodiment, the stack of thin layers comprises at least one dielectric coating comprising at least one dielectric layer consisting of a nitride or an oxynitride of aluminum and/or of silicon or of a mixed zinc tin oxide, preferably having a thickness of between 20 and 70 nm.

Advantageously, the stack may in particular comprise a dielectric layer based on silicon nitride and/or aluminum nitride located below and/or above at least one part of the functional coating. The dielectric layer based on silicon nitride and/or aluminum nitride has a thickness:
of less than or equal to 100 nm, less than or equal to 80 nm, or less than or equal to 60 nm, and/or
of greater than or equal to 15 nm, greater than or equal to 20 nm, or greater than or equal to 30 nm.

The dielectric coating(s) located below the functional coating(s) may comprise a single layer consisting of a nitride or an oxynitride of aluminum and/or of silicon, having a thickness of between 30 and 70 nm, preferably of a layer consisting of silicon nitride, optionally additionally comprising aluminum.

The dielectric coating(s) located above the functional coating(s) may comprise at least one layer consisting of a nitride or an oxynitride of aluminum and/or of silicon, having a thickness of between 30 and 70 nm, preferably of a layer consisting of silicon nitride, optionally additionally comprising aluminum.

The stack of thin layers may optionally comprise a protective layer such as a scratch-resistant layer. The protective layer is preferably the final layer of the stack, that is to say the layer furthest from the substrate coated with the stack (before heat treatment). These layers generally have a thickness of between 2.0 and 10.0 nm, preferably 2.0 and 5.0 nm. This protective layer can be chosen from a layer of titanium, zirconium, hafnium, zinc and/or tin, this or these metals being in the metal, oxide or nitride form.

According to one embodiment, the protective layer is based on titanium oxide. The thickness of the titanium oxide layer being between 2 and 10 nm.

The transparent substrates according to the invention are preferably made of a rigid inorganic material, for instance made of glass, or are organic, based on polymers (or made of polymer).

The transparent organic substrates according to the invention, which are rigid or flexible, can also be made of polymer. Examples of polymers suitable according to the invention comprise in particular:
polyethylene,
polyesters, such as polyethylene terephthalate (PET), polybutylene terephthalate (PBT) or polyethylene naphthalate (PEN);
polyacrylates, such as polymethyl methacrylate (PMMA);
polycarbonates;
polyurethanes;
polyamides;
polyimides;
fluoropolymers, for instance fluoroesters, such as ethylene-tetrafluoroethylene (ETFE), polyvinylidene fluoride (PVDF), polychlorotrifluoroethylene (PCTFE), ethylene-chlorotrifluoroethylene (ECTFE) or fluorinated ethylene-propylene copolymers (FEP);
photocrosslinkable and/or photopolymerizable resins, such as thiolene, polyurethane, urethane-acrylate or polyester-acrylate resins, and
polythiourethanes.

The substrate is preferably a sheet of glass or of glass-ceramic.

The substrate is preferably transparent, colorless (it is then a clear or extra-clear glass) or colored, for example blue, gray or bronze. The glass is preferably of soda-lime-silica type, but it may also be glass of borosilicate or alumino-borosilicate type.

The substrate advantageously has at least one dimension greater than or equal to 0.5 m, or 2 m and even 3 m. The thickness of the substrate generally varies between 0.5 mm and 19 mm, preferably between 0.7 and 9 mm, in particular between 2 and 8 mm, or between 4 and 6 mm. The substrate may be flat or curved, or even flexible.

The material, that is to say the transparent substrate coated with the stack, is intended to undergo a high-temperature heat treatment chosen from an annealing, for example by a flash annealing, such as a laser or flame annealing, a tempering and/or a bending. The temperature of the heat treatment may be above 200° C., 400° C., 450° C., or even above 500° C. The substrate coated with the stack may therefore be bent and/or tempered.

The material may be in the form of monolithic glazing or single glazing, laminated glazing or a multiple glazing, in particular a double glazing or a triple glazing. The invention therefore also relates to a transparent glazing comprising at least one material according to the invention. These materials are preferably glazings fitted to a building or a vehicle.

In the case of a monolithic or multiple glazing, the stack is preferably deposited on face 2, that is to say that it is found on the substrate defining the exterior wall of the glazing and more specifically on the interior face of this substrate.

A monolithic glazing comprises 2 faces; the face 1 is outside the building and thus constitutes the exterior wall of the glazing and the face 2 is inside the building and thus constitutes the interior wall of the glazing.

A double glazing comprises 4 faces; the face 1 is outside the building and thus constitutes the exterior wall of the glazing and the face 4 is inside the building and thus constitutes the interior wall of the glazing, the faces 2 and 3 being inside the double glazing. However, the stack may also be deposited on face 4.

The material may be intended:
for buildings such as a glazing unit, a partition or part of a glazed door,
for a land-based, waterborne or airborne transport vehicle (automobile, truck, train, airplane, boat) such as a roof, a side window, a light-emitting partition,
for street furniture or professional furniture,
for interior furniture,
for electronic equipment, in particular as a protective screen or visual display unit or display screen, such as a television or computer screen, a touch screen, in particular as electrode or OLED (organic light-emitting diode) support.

The invention also relates to a process for preparing a material comprising a transparent substrate coated with a stack of thin layers deposited by cathode sputtering, optionally magnetic-field-assisted cathode sputtering, the process comprises the sequence of steps below:
at least one dielectric coating comprising at least one dielectric layer is deposited on the transparent substrate, then
a silver-based functional metal coating is deposited on top of the dielectric coating comprising at least 1.0% by weight of indium relative to the weight of silver and indium in the functional metal coating, then
a dielectric coating comprising at least one dielectric layer is deposited on top of the silver-based functional metal coating,
the substrate thus coated is subjected to a heat treatment.

This heat treatment may be carried out at a temperature above 200° C., above 300° C. or above 400° C., preferably above 500° C.

The heat treatment is preferably chosen from tempering, annealing and rapid annealing treatments.

The tempering or annealing treatment is generally carried out in a furnace, respectively a tempering or annealing furnace. The whole of the material, including therefore the substrate, may be brought to a high temperature, of at least 200° C. or of at least 300° C. in the case of annealing, and of at least 500° C., or even 600° C. in the case of tempering.

The examples which follow illustrate the invention without, however, limiting it.

### EXAMPLES

Stacks of thin layers defined below are deposited on substrates made of soda-lime clear glass with a thickness of 3.9 mm.

The stacks are deposited, in a known manner, on a (magnetron process) cathode sputtering line in which the substrate travels under various targets.

For these examples, the conditions for deposition of the layers deposited by sputtering (“magnetron cathode” sputtering) are summarized in table 1.

TABLE 1

| | | Deposition | | |
|---|---|---|---|---|
| | Targets used | pressure | Gas | Index* |
| Si₃N₄ | Si:Al (92:8% by wt) | 2-15 × 10⁻³ mbar | Ar:30-60%—N₂:40-70% | 2.00 |
| NiCr | Ni:Cr (80:20 at. %) | 1-5 × 10⁻³ mbar | Ar at 100% | — |
| Ag | Ag | 2-3 × 10⁻³ mbar | Ar at 100% | — |
| InSn | In:Sn (90:10% by wt) | 1-3 × 10⁻³ mbar | Ar at 100% | — |

at.: atomic;
wt: weight;
*at 550 nm.

Table 2 lists the materials and the physical thicknesses in nanometers (unless otherwise indicated) of each layer or coating which forms the stacks as a function of their position with regard to the substrate bearing the stack (final line at the bottom of the table). The thicknesses given in this table correspond to the thicknesses before tempering.

TABLE 2

| Materials | Comparative | Invention |
|---|---|---|
| DC | Si₃N₄ (35 nm) | Si₃N₄ (35 nm) |
| Blocking layer | NiCr (0.17 nm) | NiCr (0.17 nm) |
| Functional coating | Ag (10 nm) | Ag—In sequence (cf. Tab. 3) |
| Blocking layer | NiCr (0.35 nm) | NiCr (0.35* or 0.17** nm) |
| DC | Si₃N₄ (35 nm) | Si₃N₄ (35 nm) |
| Sub. | Glass | Glass |

DC = Dielectric coating;
*Ex. 1-Ex. 10;
**Ex. 11-Ex. 13

The functional coatings of the materials according to the invention comprise at least one silver layer and one indium layer. Each silver layer and each indium layer of one and the same functional coating are respectively chosen to have the same thickness.

Table 3 defines, for each material:
the sequence of thin layers forming the functional coating,
the individual thicknesses (Indiv. th.) of each silver and indium layer,
the total thickness of the silver and indium layers of a functional coating.

The densities of the indium and of the tin are 7.31 and the density of the silver is 10.5.

The indium and tin layers comprise 90% by weight of indium and 10% by weight of tin. In order to be free of proportions of tin, an estimated indium thickness (Est. In th.) corresponding to the thickness of the indium layer if it did not comprise tin was calculated (Indiv. th. In ×90/100).

In order to evaluate the relative proportions of silver and indium, the weights of silver and indium per cm² in the functional coating were determined. The weight of indium relative to the weight of indium and silver in the functional coating corresponds to: % In=[(weight of In/cm²)/(weight of In/cm²+weight of Ag/cm²)×100].

The following abbreviations are used in table 3:
Indiv. th.: Thickness of a silver layer or of an indium layer forming the functional coating, in nm;
Total th.: Total thickness of the silver layers and of the indium and tin layers forming the functional coating;
Est. In th.: Estimated indium thickness;
% In: proportions by weight of indium relative to the weight of silver and indium in the functional metal coating.

| | | Indiv. th. | | Total th. | | Est. | Weight | | |
|---|---|---|---|---|---|---|---|---|---|
| Tab. 3 | Sequence | Ag | InSn | Ag | InSn | In th. | Ag/cm² | In/cm² | % In |
| Inv. 1 | Ag/(In/Ag)6 | 1.23 | 0.14 | 8.6 | 0.84 | 0.76 | 90.2 | 5.5 | 5.8 |
| Inv. 2 | Ag/(In/Ag)4 | 1.72 | 0.11 | 8.6 | 0.44 | 0.40 | 90.2 | 2.9 | 3.1 |
| Inv. 3 | Ag/(In/Ag)4 | 1.72 | 0.16 | 8.6 | 0.64 | 0.58 | 90.2 | 4.2 | 4.5 |
| Inv. 4 | Ag/In/Ag | 4.3 | 0.3 | 8.6 | 0.6 | 0.54 | 90.2 | 3.9 | 4.2 |
| Inv. 5 | Ag/In/Ag | 4.3 | 1.0 | 8.6 | 2 | 1.80 | 90.2 | 13.2 | 12.7 |
| Inv. 6 | Ag/In/Ag | 4.3 | 2.0 | 8.6 | 4 | 3.60 | 90.2 | 26.3 | 22.6 |
| Inv. 7 | In/(Ag/In)2 | 4.3 | 0.67 | 8.6 | 2 | 1.80 | 90.2 | 13.2 | 12.7 |
| Inv. 8 | Ag/(In/Ag)4 | 1.72 | 0.11 | 8.6 | 0.44 | 0.40 | 90.2 | 2.9 | 3.1 |
| Inv. 9 | In/Ag/In | 8.6 | 0.3 | 8.6 | 0.6 | 0.54 | 90.2 | 3.9 | 4.2 |
| Inv. 10 | Ag/(In/Ag)4 | 2.4 | 0.11 | 12 | 0.44 | 0.40 | 125.9 | 2.9 | 2.2 |
| Inv. 11 | Ag/(In/Ag)4 | 2.8 | 0.13 | 14 | 0.5 | 0.45 | 146.9 | 3.3 | 2.2 |
| Cmp. | Ag | 12 | — | 12 | — | — | — | — | — |
| 12 | | | | | | | | | |
| Cmp. | Ag | 14 | — | 14 | — | — | — | — | — |
| 13 | | | | | | | | | |
| Cmp. | Ag | 10 | — | 10 | — | — | — | — | — |
| 14 | | | | | | | | | |

The substrates coated with the stacks undergo a thermal tempering type heat treatment for 10 minutes at a temperature of 640° C. (HT).

In order to evaluate the chemical resistance of the stack, an accelerated aging test, referred to as a test of resistance to high humidity, was carried out. This test consists in placing a material in an oven heated at 120° C. for 480 minutes having a relative humidity of 100% (RH). The visual observation of the material according to the invention after heat treatment makes it possible to note the absence of haze.

The sheet resistivity (Rsq), measured in ohms with a Nagy device, corresponds to the resistance of a sample having a width equal to the length (for example 1 meter) and having any thickness. The sheet resistivity is measured:
before and after heat treatment,
before and after accelerated aging on materials that have undergone a high-temperature heat treatment.

In order to evaluate the hold of the stack on the substrate, an adhesion test corresponding to the cross-cut test according to the standard EN ISO 2409 was carried out (“tape test” or T. ad.). This test consists in producing a lattice pattern with the cutter and then in applying a piece of standardized adhesive that is removed after a certain period of time. The inspection of the cross-cut surface after removal of the adhesive makes it possible, depending on the amount of thin layers pulled off, to characterize the hold of the stack. According to the invention, the test is described as:
“OK” when no removal of thin layers is observed,
“NOK” when removal of thin layers is observed.

Finally, certain optical characteristics, when the materials are assembled as single glazing, the stack being positioned on face 2, face 1 of the glazing being the outermost face of the glazing, were measured, including:
R_{L} indicates: the light reflection in the visible region in %, measured under the illuminant A with the 2° observer on the side of the interior face, face 2;
a*R and b*R indicate the colors in reflection a* and b* in the L*a*b* system, measured under the illuminant D65 with the 10° observer on the side of the outermost face and measured thus perpendicularly to the glazing;
T_{L} indicates the light transmission in the visible region in %, measured under the illuminant A with the 2° observer;
a*t and b*t indicate the colors in transmission a* and b* in the L*a*b* system, measured under the illuminant A with the 2° observer on the side of the outermost face and measured thus perpendicularly to the glazing;
Abs. indicates the light absorption in the visible region in %, measured under the D65 illuminant with the 10° observer.

The following abbreviations are used in tables 4 and 5:
HT: Heat treatment,
ΔRht: Variation in sheet resistivity between after and before heat treatment,
ΔRhr: Variation in sheet resistivity between after heat treatment and after heat treatment and high-humidity test,
R.: Sheet resistivity.

| | % | | Reflection | | | Transmission | | | | | T. | | |
|---|---|---|---|---|---|---|---|---|---|---|---|---|---|
| Tab.4 | In. | HT | R_{L} | a*R | b*R | T_{L} | a*t | b*t | Abs | R. | ad. | ΔRht | R. |
| Inv. 1 | 5.8 | Before | 11.3 | 1.9 | 7.6 | 62.2 | −2.4 | −3.1 | 26 | 28.3 | OK | −4.5 | — |
| | | After | 11.3 | 4.7 | 7.5 | 62.7 | −3.4 | −5.8 | 26 | 23.5 | OK | | — |
| Inv. 2 | 3.1 | Before | 10.2 | 0.7 | 5.8 | 65.8 | −1.8 | −2.3 | 24 | 23 | OK | −4.7 | — |
| | | After | 9.7 | 5.5 | 6.2 | 68.6 | −3.7 | −4.5 | 22 | 18.3 | OK | | <20 |
| Inv. 3 | 4.5 | Before | 10 | 1.5 | 4.2 | 66.4 | −1.9 | −1.8 | 24 | 26.3 | OK | −4.1 | — |
| | | After | 10.8 | 5.5 | 8.8 | 65.8 | −3.2 | −5.3 | 23 | 22.2 | OK | | — |
| Inv. 4 | 4.2 | Before | 9.4 | 0.7 | 4.8 | 68.5 | −1.5 | −1.8 | 22 | 19 | OK | +6.2 | <20 |
| | | After | 9.8 | 3.3 | 6.5 | 65.8 | −2.7 | −4.7 | 24 | 25.2 | OK | | — |
| Inv. 5 | 12.7 | Before | 10.7 | 2.2 | 8.6 | 62 | −2 | −2.7 | 27 | 23 | OK | −1.1 | — |
| | | After | 11.5 | 6.7 | 11.3 | 61.6 | −3.9 | −4.7 | 27 | 21.9 | OK | | — |
| Inv. 6 | 22.6 | Before | 13.8 | 2.3 | 12.6 | 51.7 | −2.1 | −3.5 | 34 | 30.7 | OK | +1.8 | — |
| | | After | 14.9 | 5 | 12.4 | 50.4 | −3.4 | −3.8 | 35 | 32.5 | NOK | | — |
| Inv. 7 | 12.7 | Before | 11.8 | 2.4 | 9.8 | 58.9 | −2.3 | −3.4 | 29 | 26.4 | OK | +3.7 | — |
| | | After | 12.2 | 6.3 | 10.9 | 59.5 | −3.9 | −5.2 | 28 | 29.7 | OK | | — |
| Inv. 8 | 3.1 | Before | 9.8 | 1.1 | 5.2 | 67.3 | −1.7 | −2.2 | 23 | 22.4 | OK | −5.2 | — |
| | | After | 9.7 | 5.6 | 8.4 | 67.6 | −3.3 | −5.3 | 23 | 17.2 | OK | | <20 |
| Inv. 9 | 4.2 | Before | 9.6 | 1.1 | 4.1 | 68.6 | −4.6 | −1.6 | 22 | 17.8 | OK | — | <20 |
| | | After | 12 | 0.8 | 7.8 | 59.9 | −2.1 | −4.7 | 28 | — | NOK | | — |
| Inv. 10 | 2.2 | Before | 9 | 6 | 11.6 | 69 | −2.5 | −2.4 | 22 | 9.6 | OK | −3.1 | <10 |
| | | After | 12.9 | 9.6 | 17.8 | 68.2 | −4.1 | −5.9 | 19 | 6.5 | OK | | <10 |
| Inv. 11 | 2.2 | Before | 12.3 | 8.7 | 19.9 | 60 | −3.4 | −4.2 | 28 | 8.5 | — | −1.5 | <10 |
| | | After | 18.8 | 8.6 | 23.6 | 55.9 | −4.2 | −10.4 | 25 | 7.0 | — | | <10 |
| Cmp. | — | Before | 10 | 6 | 12.9 | 65.1 | −2.3 | −2.9 | 25 | 7.6 | — | — | <10 |
| 12 | | | | | | | | | | | | | |
| Cmp. | — | Before | 12.1 | 9 | 19.2 | 62.4 | −3.2 | −4 | 25 | 5.9 | — | +0.3 | <10 |
| 13 | | After | 18.6 | 8.9 | 23.7 | 58 | −4.2 | −10.7 | 23 | 6.2 | — | | <10 |
| Cmp. | — | After | 7.1 | — | — | 71.0 | −3.6 | −4.7 | — | 11.3 | | | <20 |
| 14 | | | | | | | | | | | | | |

| | | Reflection | | | Transmission | | | | | | |
|---|---|---|---|---|---|---|---|---|---|---|---|
| Tab. 5 | HT/TR | R_{L} | a*R | b*R | T_{L} % | a*t | b*t | Abs | R | ΔRrh | R |
| Inv. 10 | After HT | 12.9 | 9.6 | 17.8 | 68.2 | −4.1 | −5.9 | 18.9 | 6.5 | — | <10 |
| | After RH | 12.2 | 9.9 | 17.4 | 69.1 | −4.1 | −5.4 | 18.7 | 6.4 | −0.1 | <10 |
| | After RH | — | — | — | — | — | — | — | 7.9 | +1.4 | <10 |
| Cmp. 14 | After HT | 7.1 | — | — | 71.0 | −3.6 | −4.7 | — | 7.9 | — | <10 |
| | After RH | — | — | — | — | — | — | — | 11.3 | +3.4 | <20 |

### Resistance to the Heat Treatment:

These examples show that in the majority of cases, the addition of indium to the silver in the functional coating does not impair the hold of the stack on the substrate insofar as the adhesion tests are satisfied.

When the functional coating comprises a sequence of several silver and indium layers, better results are obtained when this sequence of layers begins and/or finishes with a silver layer.

Better results are also obtained when the functional coating comprises less than 5% by weight of indium. Examples Inv.5. Inv.6 and Inv.7 have high sheet resistivity values.

When the functional coatings comprise at least 3% by weight of indium, a gain in resistivity is observed following the heat treatment that is expressed by values of ΔRht that are negative and less than −2. This tendency is not systematically observed when the functional coatings comprise less than 3% by weight of indium since the sheet resistivity values are then very low and in particular less than 10 ohm per square.

When the functional coatings comprise proportions of less than 4% and better still of 1 to 3% by weight of indium relative to the weight of indium and silver, the sheet resistivity is not increased significantly due to the addition of indium compared to a similar stack based on a functional coating solely based on silver. In particular, for examples Inv.10 and Inv.11 comprising less than 2.5% by weight of indium relative to the weight of indium and silver, sheet resistivities of less than 10 ohm before heat treatment are observed.

But above all, the sheet resistivity after heat treatment is not increased significantly, or is even lowered. For this, the examples according to the invention Inv.10 and Inv.11 before and after heat treatment can be compared with the comparative examples Cmp.12 and Cmp 13.

Since the resistivity is in general proportional to the emissivity, this means that the excellent thermal performances are not modified due to the addition of indium.

### Resistance to Wet Corrosion

The comparative example (Cmp.14), that does not comprise indium in the functional coating, has, after aging, a much higher sheet resistivity than that of the example according to the invention Inv.10 (11.3 ohm for Cmp.14 and 6.4 or 7.9 ohm for Inv.10). The comparative material is therefore less effective than the material of the invention after aging.

Furthermore, this significant increase in the sheet resistivity following the accelerated aging is accompanied by corrosion that is plainly visible.

### In Conclusion

The material according to the invention, following a high-temperature heat treatment and following an aging test is not hazy. No increase in the sheet resistivity is observed either. These two observations make it possible to conclude that the solution of the invention makes it possible to considerably improve the chemical resistance of the stack.

The functional coating according to the invention makes it possible to maintain high light transmission values after a heat treatment, and this despite the not insignificant proportions of indium used.

The solution of the invention therefore makes it possible to obtain a stability of the characteristics of the glazing before and after the heat treatment.

The excellent chemical stability of the stack according to the invention enables the use of the material with the stack positioned either on an outer face, that is to say in contact with the ambient air, or inner face of a substrate.

1. A material comprising a transparent substrate coated with a stack of thin layers comprising at least one silver-based functional metal coating, at least two dielectric coatings comprising at least one dielectric layer, so that each functional metal coating is positioned between two dielectric coatings, wherein the functional metal coating comprises at least 1.0% by weight of indium relative to the weight of silver and indium in the functional metal coating.

2. The material as claimed in claim 1, wherein the functional coating comprises a metal layer based on an alloy of silver and indium.

3. The material as claimed in claim 1, wherein the functional coating comprises at least one indium-based metal layer and at least one silver-based metal layer.

4. The material as claimed in claim 1, wherein the functional coating comprises at most 5.0% by weight of indium relative to the weight of silver and indium in the functional metal coating.

5. The material as claimed in claim 1, wherein the functional coating comprises 1.0% to 3.0% by weight of indium relative to the weight of silver and indium in the functional metal coating.

6. The material as claimed in claim 1, wherein the functional metal coating comprises 0.05% to 1.0% by weight of tin relative to the weight of silver, indium and tin in the functional metal coating.

7. The material as claimed in claim 1, wherein the silver-based functional metal coating has a thickness of between 5 and 20 nm.

8. The material as claimed in claim 1, wherein the functional coating comprises at least one indium-based metal layer and at least two silver-based metal layers, so that each indium-based metal layer is positioned between two silver-based metal layers.

9. The material as claimed in claim 1, wherein the stack of thin layers additionally comprises at least one blocking layer located in contact with and above and/or below the functional metal coating selected from metal layers, metal oxide layers and metal oxynitride layers of one or more elements selected from titanium, nickel, chromium, tantalum and niobium.

10. The material as claimed in claim 1, wherein the stack of thin layers comprises a single functional coating.

11. The material as claimed in claim 1, wherein the stack of thin layers comprises at least one dielectric coating comprising at least one dielectric layer consisting of a nitride or an oxynitride of aluminum and/or of silicon.

12. The material as claimed in claim 1, wherein the dielectric coating located below the functional coating comprises a single layer consisting of a nitride or an oxynitride of aluminum and/or of silicon, having a thickness between 30 and 70 nm.

13. The material as claimed in claim 1, wherein the dielectric coating located above the functional coating comprises at least one layer consisting of a nitride or an oxynitride of aluminum and/or of silicon, having a thickness between 30 and 70 nm.

14. The material as claimed in claim 1, wherein the transparent substrate is:
made of glass or
made of polymer.

15. A process for preparing a material comprising a transparent substrate coated with a stack of thin layers deposited by cathode sputtering, optionally magnetic-field-assisted cathode sputtering, the process comprising the sequence of steps below:
depositing at least one dielectric coating comprising at least one dielectric layer on the transparent substrate, then
depositing a silver-based functional metal coating above the dielectric coating comprising 1% to 5% by weight of indium relative to the weight of silver and indium in the functional metal coating, then
depositing a dielectric coating comprising at least one dielectric layer above the silver-based functional metal coating,
subjecting the substrate thus coated to a heat treatment.

16. The material as claimed in claim 9, wherein the at least one blocking layer is selected from the group consisting of Ti, TiN, TiOx, Nb, NbN, Ni, NiN, Cr, CrN, NiCr, and NiCrN.

17. The material as claimed in claim 14, wherein the transparent substrate is:
made of soda-lime-silica glass or
made of polyethylene, polyethylene terephthalate or polyethylene naphthalate.
